(19) United States
(12) Patent Application Publication
(10) Pub. No.: US 2025/0041152 A1
(43) Pub. Date: Feb. 6, 2025

(54) Wellness Device for Eyes

(71) Applicant: Michael Charles Larson, Colorado Springs, CO (US)

(72) Inventor: Michael Charles Larson, Colorado Springs, CO (US)

(21) Appl. No.: 18/738,009

(22) Filed: Jun. 9, 2024

Related U.S. Application Data
(60) Provisional application No. 63/472,281, filed on Jun. 10, 2023.

(51) Int. Cl. A61H 23/02

(52) U.S. Cl. CPC A61H 23/0236; A61H 2201/0153; A61H 2201/1207; A61H 2201/1604; A61H 2205/024

(57) ABSTRACT

A method and device for mechanically stimulating the trabecular meshwork of an eye is disclosed. The device acts non-invasively to vibrate a closed eyelid on areas which are in close proximity to the trabecular meshwork, which is located in tissues below the closed eyelid. The vibration at the surface of the eyelid induces mechanical vibratory waves which conduct through the tissues of and around they eye, causing the movement and deformation of the trabecular meshwork. This action results in clearing the trabecular meshwork of substances, such as debris, which may accumulate in the open-cell pores of, and on the structural surfaces of, the trabecular meshwork. If not cleared, such substances debris can increase the resistance to the healthy outflow of fluid from the eye which elevates the intraocular pressure and can lead to serious health problems, especially glaucoma.

### BACKGROUND OF THE INVENTION

The present invention relates to a treatment for elevated intraocular pressure, a condition characterized by the pressure of the fluids within an eyeball being higher than the healthy range pressure, cited by many to correspond to pressures above 21 mmHg. The pressures are commonly measured by an instrument such as a tonometer. Elevated intraocular pressure has been linked to the development of glaucoma. More particularly, the present invention relates to a method and device for vibrating the trabecular meshwork of an eye for the purpose of enhancing the outflow of aqueous humor, a fluid produced inside the eye, by clearing debris out from, and preventing the accumulation of debris on, the trabecular meshwork through which exiting fluid flows.

FIG. 1 represents a cross section view of an eye showing representations of some of the pertinent anatomical structures related to the creation, flow path, and exit for fluid that normally fills the anterior chamber of the eye. Vitreous humor 109 is a viscous fluid that fills the posterior chamber of the eye and fills the majority of the eyeball. Aqueous humor (also called aqueous fluid) 111, fills the spaces in the anterior chamber of the eye, including between the cornea 102 and the iris 103, and around the lens 104. Aqueous humor is produced by the ciliary bodies 105. The aqueous humor makes its way past the lens 104 and flows through the hole in the iris 103 called the pupil, to the iridocorneal angle 112, which is the place where the outer periphery of the cornea 102 and the outer periphery of the iris 103 meet and connect to the sclera 101. Fluid flows out of the eyeball through the trabecular meshwork 106, an open-cell, porous structure which forms a ring around the iridocorneal angle 112. As it exits, the aqueous humor 111 takes debris out of the eye that would otherwise build up inside the eye and obscure vision by interfering with light passing to the retina 108. The intraocular pressure is dictated by the amount of pressure needed in the eyeball to push the aqueous humor through the trabecular meshwork at a flowrate which is equal to the rate of fluid production by the ciliary bodies. In a healthy eye, one maintaining a proper intraocular pressure, the mesh-like structure of the trabecular meshwork 106 provides little resistance to fluid outflow as the aqueous humor exits the eye and flows into Schlemm's Canal 107.

The intraocular pressure can elevate to dangerous levels if the resistance to fluid outflow increases, as can be the case when debris builds up on and in the porous structure of the trabecular meshwork. Increased resistance causes back pressure, elevating the intraocular pressure of the aqueous humor to a higher equilibrium value needed to balance the rate of fluid production by the ciliary bodies and the rate of outflow through the trabecular meshwork.

The trabecular meshwork is thus a key component of the eye's drainage system. Referring again to FIG. 1, the trabecular meshwork is situated circumferentially around the eye at the junction of the cornea 102 and iris 103 (a junction called the iridocorneal angle 112), where these join the sclera 101. The trabecular meshwork's primary function is to regulate the outflow of aqueous humor 111, the clear fluid that fills the anterior chamber and a portion of the posterior chamber of the eye. By controlling the outflow of aqueous humor 111, the trabecular meshwork 106 helps maintain normal intraocular pressure of the aqueous humor, which is crucial for the health of the eye and the prevention of glaucoma.

The trabecular meshwork 106 is a porous, open cell (i.e., fluid can pass through) mesh structure made up of beams and sheets composed of types I, III, IV, and VI collagen. It consists of several layers: (1) the uveal meshwork, which is the innermost layer, adjacent to the anterior chamber, (2) the corneoscleral meshwork, which is the middle layer, providing a pathway for fluid through more tightly packed pores, and (3) the juxtacanalicular (cribriform) tissue, which is the outermost layer, adjacent to Schlemm's canal 107, containing fewer cells but more extracellular matrix.

Several substances have been identified as clogging trabecular meshwork and obstructing fluid flowing out of the eye, including cellular debris, pigment granules, extracellular matrix material, proteins and other macromolecules. Types of cellular debris include inflammatory cells (e.g., in uveitis) and red blood cells (e.g., following a hyphema). Pigment granules shed off the iris and can accumulate in the trabecular meshwork, which can also contribute to blockage. Likewise, excessive proteins and glycoproteins can flake off the eye's lens and accumulate in the trabecular meshwork clogging the drainage system. Extracellular matrix material can lodge in the trabecular meshwork as a result of aging, chronic inflammation, or other pathophysiological processes. Clogging of the trabecular meshwork can result in elevated pressure in the eye and glaucoma.

Glaucoma is a leading cause of blindness worldwide. One mechanism causing this irreversible loss of vision involves damage to the optic nerve fibers lining the retina 108 because of the high strains and stresses induced by elevated intraocular pressures. This damage is particularly prone to occur at the location of the optic nerve head at the posterior of the eyeball where nerve fibers are severely bent as they transition from being coincident with the retinal surface to being part of the bundled optic nerve 110 oriented nearly perpendicular to the retinal surface.

Treatments for glaucoma, which often do not begin until after some vision loss has occurred, aim to improve the outflow of aqueous humor through the trabecular meshwork. Current treatments include medications (e.g., prostaglandin analogs), laser therapy (e.g., trabeculoplasty), and surgical interventions (e.g., trabeculectomy). All of these treatments come with serious potential side effects and all typically require repeated administrations, including the surgical ones. The present invention represents a drug-free, easy-to-administer, relatively low-cost, preventative treatment that can help maintain eye wellness by keeping the trabecular meshwork clear of clogging debris, and an alternative to existing treatments for helping lower intraocular pressure by clearing debris that has already accumulated. As is typical for porous structures possessing a high degree of elasticity, debris can be removed from the trabecular meshwork by mechanical deformation, particular vibratory excitation.

### SUMMARY OF THE INVENTION

The invention is a method of mechanically vibrating the trabecular meshwork, non-invasively, through contact with the closed eyelid, in order to clear and to keep clear the trabecular meshwork of any substance, e.g., debris, which may restrict normal fluid outflow and which may result in elevated intraocular pressure. The purpose for the invention is to promote eye wellness by maintaining proper fluid outflow through the trabecular meshwork at a normal pressure level by keeping the trabecular meshwork free from clogging debris.

The present invention can be operated and used by one's self. A distal end of the device, represented schematically in FIG. 2 as an exemplary annular ring 200, will move in a vibratory manner, i.e., time varying, oscillatory motion characterized by a frequency. This motion induces mechanical vibratory waves to be conducted through the tissues of and around the eye to induce therapeutic motion and deformation of the trabecular meshwork. The frequencies of the vibration imparted to the eyelid are in the sonic and subsonic ranges, i.e., without causing tissue damage at the points of contact as often results for induced vibrations at ultrasonic frequencies, such as cutting. The vibration of the distal end 200 can be achieved by a variety of mechanical and electromechanical mechanisms, including one or more motors with unbalanced rotors or output shafts, one or more motors with rotating cams, one or more electromagnets with time varying electrical input, one or more piezoelectric crystals subjected to time varying voltage, or some other mechanism design, including many to be found in the public domain. The distal end of the device 200 has a surface 201 which comes in contact with the closed eyelid that is made of a material which is biocompatible with touching skin, (silicone is one example of such a material that could form a coating on the surface), and which is compliant enough to not abrade the skin while being stiff enough to transmit vibratory energy to the closed eyelid, (again layer of silicone serves as a suitable example). The surface 201 can be nominally smooth or it can have features to promote comfort such as protruding fingers, bristles, and/or bumps.

In FIG. 3 this exemplary distal portion of the device 200 is shown in a cross-section representation being in contact with a closed eyelid 300. The ring is centrally located over the cornea, which resides just below the eyelid; the ring has a diameter which is nominally the same as the diameter of the cornea. Thus the ring contacts the closed eyelid all around the area where the closed eyelid overlays the entire circle of the iridocorneal angle 111 simultaneously. This position puts the surface 201 of the vibrating distal end 200 in close proximity to the trabecular meshwork.

Placement of the distal end 200 such that it contacts the eyelid in is accomplished manually. The portion of the present invention which can be grasped and held by a hand may physically be an extension of the distal end, or it may be a distinct proximal end. An example of the latter is included as an exemplary embodiment shown in FIG. 5, where a hand of the user 500 is shown holding the device 400 by a handle 401 such that the vibrating distal end 200 is in contact with the eyelid.

The vibration imparted to the closed eyelid will conduct as mechanical waves through tissue structures of the around the iridocorneal angle to stimulate the trabecular meshwork. The stimulation will cause movement and deformation of the trabecular meshwork and thus will cause unwanted debris and material to clear from the trabecular meshwork.

Computational simulations and measurements on eyes show there are multiple modal frequencies in the subsonic and sonic frequency ranges that will be especially efficacious at stimulating the trabecular meshwork directly and stimulating the corneal angle to flex the trabecular meshwork. In addition to the analyses of others, the inventor has completed finite element analyses on detailed structural models of the human eye which confirm the existence of excitation frequencies in the subsonic and lower sonic frequency ranges that induce significant deformation of the trabecular meshwork. The inventor has also done testing with eye specimens that support this finding. Since the particular values for natural frequencies of various eye structures, such as sub-portions of the trabecular meshwork itself and portions of the corneal/iris/sclera structures to which it is attached, will vary from eye to eye, the capability of the present invention to vary the vibration frequencies of the distal portion of the device, including, for example, the capability to automatically sweep across frequencies in the subsonic and/or sonic frequency ranges, is a desirable, albeit not necessary, feature.

A handle, again either an integral extension of the distal end or a distinct proximal end, will give the user control of the proper placement of the device at a comfortable pressure between the device and closed eyelid. The present invention will have relevant controls, which may include functions such as on/off, mode (e.g., automatic or manual frequency and amplitude settings), timer, etc., and indicators, which may include: power, battery level, current settings, usage history, etc. In the exemplary embodiment, these controls are contained on and in the proximal end handle.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying drawings illustrate the preferred embodiment of the invention and together with the description serve to explain the principles of the invention. The drawings and description are not exhaustive of all the possible embodiments of the present invention.

FIG. 1 is a cross section of an eye showing representations of some of the pertinent anatomical structures, including the sclera 101, cornea 102, iris 103, lens 104, ciliary bodies 105, trabecular meshwork 106, and Schlemm's canal 107, retina 108, vitreous humor 109, optic nerve 110, aqueous humor 111, and the iridocorneal angle 112,

FIG. 2 is a diagram of a ring-shaped distal end 200 of an exemplary embodiment. It is the distal end 200 which vibrates and which is placed in contact with an eyelid to impart mechanical vibration waves that will conduct through tissues of and around the eye to include the trabecular meshwork. The surface 201 which contacts the eyelid can be smooth or can have features on the surface such as bumps, finger-like protrusions, bristles, and the like, to fit the desires of the user. The material on the contact surface 201 will be biocompatible with skin, such as silicone.

FIG. 3 is the exemplary ring-shaped distal end 200 in contact with a closed eyelid 300. The vibratory mechanical waves will be imparted to an exemplary annular treatment area in close proximity to the entire periphery of the iridocorneal angle 112 simultaneously, and thus will be conducted to, and will stimulate the trabecular meshwork 106.

FIG. 4 is a view of an exemplary embodiment of a device 400 according to the principles of the present invention. It has a distal end formed as a ring 200 which makes contact with an eyelid and vibrates, and a proximal end forming a handle 401 incorporating controls and indicators 402 for relevant functionality, e.g., turning the device on and off, for selecting a constant frequency or selecting to sweep up and down through a range of frequencies, battery power level, etc.

FIG. 5 is a drawing of the exemplary embodiment 400 in use. The user 500 holds the device 400 by the handle 401 so that the vibrating distal end 200 is in contact with the eyelid. The handle mounted controls are accessible during operation.

FIG. 6 is a schematic representation of the components comprising the exemplary embodiment of the device 400, which are revealed by the removal of an access cover of the proximal end handle 401. Inside the handle are mounted the electronics 600 to provide the needed electrical voltage and electrical current, especially for the motor 601. The electronic components include a motor speed controller and a power management module. There is a rechargeable power source; a battery 602 is shown here. There is a port 603 for connecting an external power source to recharge the battery. The means for creating the vibration of the distal end in this exemplary embodiment is a DC motor 601 having an unbalanced weight 604 on the output shaft. The motor housing 605, which vibrates when the motor is running because of forces created by accelerating the non-symmetrically distributed mass of the unbalanced weight mounted on the motor output shaft, is attached to a stiff metal beam 606 which is attached to the distal end 200 and causes the distal end to vibrate. The support collar 607 of the shaft acts as a pivot point, the position of which can be adjusted in the direction oriented along the length of the shaft in order to vary the amplitude of the displacement of the vibration of the distal end 200. The amplitude of the motion of the distal end has a nominal value of 0.5 mm. In this exemplary embodiment, the amplitude can be manually varied up or down a few tenths of a millimeter from that nominal value.

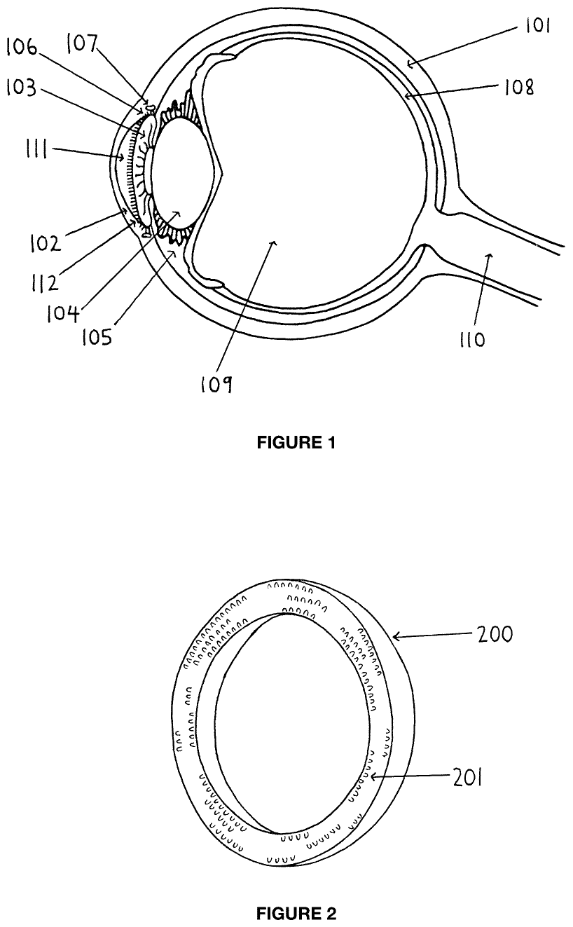

### DETAILED DESCRIPTION OF THE PREFERRED EMBODIMENT

Reference is now made in detail to the exemplary embodiments of the invention, examples of which are illustrated in the included drawings. The same reference numbers are used throughout the drawings to refer to the same parts.

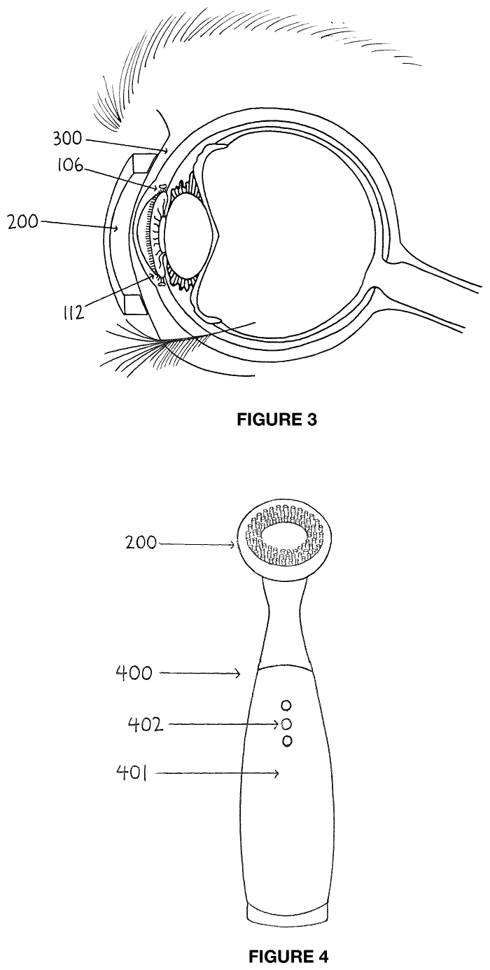

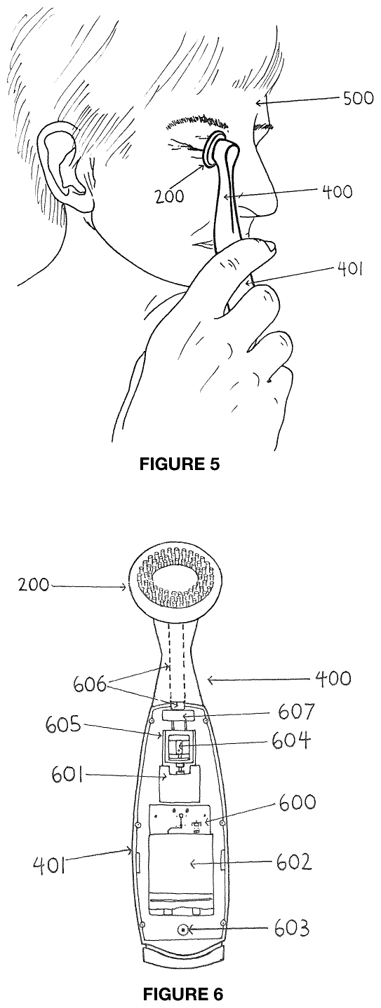

In an exemplary embodiment of the present invention as shown in FIG. 4 and shown in use in FIG. 5, device 400 imparts a vibration to the trabecular meshwork. The distal end 200, shown in isolation in FIG. 2, of the device contacts a closed eyelid, as shown in FIG. 3. The vibration of the distal end 200 imparts mechanical waves of vibration which pass through tissues in and around the eye to stimulate the trabecular meshwork 106. The mechanical vibration is created by the motor 601 with an unbalanced output shaft 604, mounted by bearing surfaces inside a housing 605 shown in FIG. 6. The housing is attached to a beam 606 that transmits the oscillatory vibration motion to the distal end 600. This means of transforming the energy stored in a battery 602 into vibratory motion, a process facilitated by the electronics module 600, is contained within the proximal end handle 401 shown in both FIG. 4 and, with an access cover removed in FIG. 6. FIG. 4 also shows controls and indicators for operation of the device 402 conveniently located on the handle 401.

As stated above, the means of vibratory motion, i.e., oscillatory motion, of the distal end can be a variety of mechanisms. The choice for any particular embodiment of the present invention can be made considering the context, such as cost of fabrication. Some of the common mechanisms for inducing vibratory motion include the following:

Cam mechanisms: A cam rotating (such as one connected to an electric motor) in contact with a follower can cause periodic motion in the follower, leading to vibrations. Unbalanced rotors or output shafts (as described in the exemplary embodiment herein): An unbalanced rotor or output shaft of a motor, i.e., the mass is not distributed symmetrically across the axis of rotation, can cause vibratory motion due to centrifugal forces acting on the unbalanced mass as it rotates.
Crystal oscillators: Quartz crystals exhibit piezoelectric properties, vibrating at precise frequencies when an electric field is applied.
Electromagnets and solenoids: An electrical circuit containing an inductor, and usually a capacitor, can oscillate a magnetic material by exerting a force that moves the material by displacing it from an equilibrium position, often determined by a spring. These are used in speakers, relays, and various types of actuators.
Acoustic waves: Vibrations in air or other media can propagate as sound waves and induce vibrations in solid structures.
Thermal changes: Materials can experience vibratory motion due to periodic heating and cooling, leading to expansion and contraction cycles.
Muscle contractions: Muscles can produce vibratory motion through periodic contractions.
Magnetostriction: Certain materials change shape or dimensions in the presence of a magnetic field, leading to vibratory motion. This principle is used in magnetostrictive actuators.

From the preceding, it can be appreciated that the present invention provides a method and system for treating elevated intraocular pressure, and hence may prevent glaucoma and may aid glaucoma suffers. The present disclosure describes a device that imparts mechanical stimulus which is conducted through tissue in and around the eye to stimulate, move, and deform the trabecular meshwork. This mechanical stimulus causes the trabecular meshwork to shed undesirable accumulation of debris or other unwanted substances that can restrict fluid outflow and thus raise intraocular pressure. Hence the present invention facilitates outflow of aqueous fluid for the purpose of achieving healthy intraocular pressure levels. The present invention is illustrated herein by example, and various modifications may be made by a person of ordinary skill in the art.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of treating elevated intraocular pressure by moving and deforming the trabecular meshwork, by vibrating a closed eyelid at sonic or subsonic frequencies, so that vibrational waves are conducted through tissues in and around the eye, and thus clearing out debris located in or on the trabecular meshwork for the purpose of reducing the resistance to fluid flowing out of the eye.

2. The method of claim 1 where the application of the vibratory stimulation is applied to the eyelid in an annular ring coinciding with the location of the ocular angle below the eyelid in proximity to the trabecular meshwork.

3. A method of treating elevated intraocular pressure by providing a device, a portion of which vibrates at sonic or subsonic frequencies when in contact with the closed eyelid to induce mechanical vibrations in tissues in and around the eye, especially the trabecular meshwork, thus moving and deforming the trabecular meshwork and clearing out substances in or on the trabecular meshwork for the purpose of reducing the resistance to fluid flowing out of the eye.

4. The method of claim 3 wherein the frequency of the applied vibrations is varied.

5. The method of claim 3 wherein the device excites resonance in tissues of and around the eye, or assemblies of tissue structures in and around the eye, for the purpose of enhancing the movement and deformation of the trabecular meshwork.

6. A device comprising a vibrating structure, which vibrates at subsonic or sonic frequencies to impart mechanical stimulation to the closed eyelid or the purpose of inducing mechanical vibrational waves which conduct through tissues of and near the eye for the purpose of moving and deforming the trabecular meshwork and as a consequence clear out substances in or on the trabecular meshwork to reduce the resistance to fluid flowing out of the eye.

7. The device of claim 6 wherein the vibrating structure is ring possessing a diameter similar to the diameter of cornea such that the structure contacts the closed eyelid over an annular, or nearly annular area, so the vibrating structure will be in proximity to the trabecular meshwork.

8. The device of claim 7 wherein the frequency of the applied vibrations can be varied.

9. The device of claim 7 wherein the device produces mechanical vibrations at frequencies that excite resonance in structures of the eye that will enhance deformation of the trabecular meshwork.

10. A device comprising a vibrating ring, which vibrates at subsonic or sonic frequencies; which possesses a diameter similar to the diameter of the cornea such that the structure contacts the closed eyelid over an annular, or nearly annular, area coinciding in proximity to the trabecular meshwork; which imparts mechanical stimulation to the closed eyelid at locations near the trabecular meshwork for the purpose of vibrating the of the trabecular meshwork by the conduction of vibrational waves through tissues of the eye; which, as a consequence, clears out substances in or on the trabecular meshwork for the purpose of reducing the resistance to fluid flowing out of the eye.

11. The device of claim 10 wherein the frequency of the applied vibrations can be varied.

12. The device of claim 10 wherein the device produces mechanical vibrations at frequencies that excite resonance in structures of the eye that will enhance deformation of the trabecular meshwork.
